(19) United States
(12) Patent Application Publication
(10) Pub. No.: US 2009/0254875 A1
(43) Pub. Date: Oct. 8, 2009

(54) PROACTIVE ROUTING SYSTEM AND METHOD

(75) Inventors: Sharad Mehrotra, Cedar Park, TX (US); Parsotam T. Patel, Austin, TX (US); Viktor Lapinskii, Austin, TX (US)

Correspondence Address: FISH & RICHARDSON P.C., P.O BOX 1022, Minneapolis, MN, 55440-1022, US

(73) Assignee: PYXIS TECHNOLOGY, INC., Austin, TX (US)

(21) Appl. No.: 12/062,394

(22) Filed: Apr. 3, 2008

(51) Int. Cl. G06F 17/50

(52) U.S. Cl. 716/12

(57) ABSTRACT

There is provided a proactive routing system and method. In some embodiments, the method includes determining slack for a net in a netlist, applying a routing condition to the net, calculating an extra delay related to the routing condition, determining a criticality of the net considering the extra delay and the determined slack, and setting a soft constraint based at least partially on the criticality.

### BACKGROUND

This section is intended to introduce the reader to various aspects of art that may be related to various aspects of the present invention, which are described and claimed below. This discussion is believed to be helpful in providing the reader with background information to facilitate a better understanding of the various aspects of the present invention. Accordingly, it should be understood that these statements are to be read in this light, and not as admissions of prior art.

A net layout may include a mapping of electrical connections within each of a variable number of layers in a semiconductor integrated circuit. Computer-driven routing systems are often used to build layouts to articulate designs to be expressed in an integrated circuit. Such systems typically use a netlist which is a description of required connections between terminals, and create a net layout to make such required connections.

To perform routing, the router receives chip technology data including various rules such as geometric rules that describe parameters and characteristics of layers on which rectangles representing wires can be generated, the minimum allowed width of any part of a trace, and the minimum allowed separation between traces. Typically, a router executes a global routing step for allocating groups of nets to be routed through corresponding general routing areas.

### BRIEF DESCRIPTION OF THE DRAWINGS

FIG. 1 is a graphical representation of an exemplary integrated circuit in accordance with some embodiments.

FIG. 2 is another graphical representation of an embodiment of an integrated circuit in which a net layout includes a routing grid.

FIG. 3 illustrates a flow chart of an exemplary technique for routing nets during design of an integrated circuit.

FIG. 4 illustrates one exemplary embodiment of a workstation in accordance with some embodiments.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions should be, made to achieve the developers' specific goals, such as compliance with system-related and business-related constraints, which may vary from one implementation to another. Moreover, it should be appreciated that such a development effort might be complex and time consuming, but would nevertheless be a routine undertaking of design and manufacture for those of ordinary skill having the benefit of this disclosure.

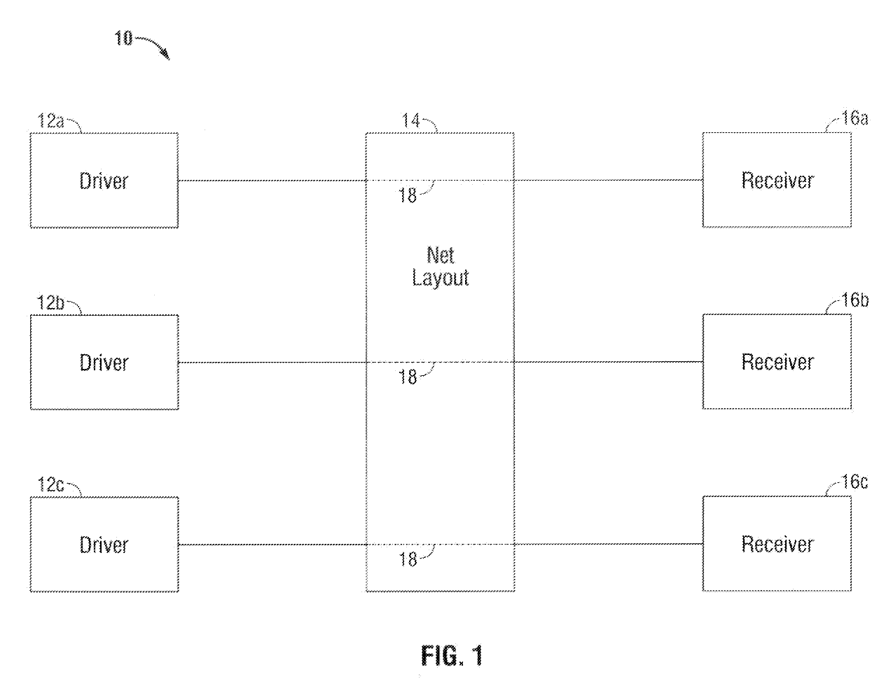

FIG. 1 is a graphical representation of an exemplary integrated circuit 10 in accordance with some embodiments. As shown, integrated circuit 10 includes a driver 12a, a net layout 14, receivers 16a and 16b. It will be appreciated however, that the illustrated structure is merely one example, and, in alternate embodiments, integrated circuit 10 may have any suitable number of drivers 12a-c, net layouts 14, and/or receivers 16a-c. For example, the integrated circuit 10 can include thousands or millions of drivers 12a-c and receivers 16a-c.

Drivers 12a-c, which are also known as a sources, are generally configured to generate or propagate a signal intended for a destination located at another location on integrated circuit 10 (receivers 16a-c, for example). In some embodiments, drivers 12a-c include a simple circuit, an instance, and/or a cell. For, example, drivers 12a-c may be a part of a logic component, such as an output pin of a flip-flop, latch, a buffer, and the like. In some embodiments, the drivers 12a-c are logic component pins. Drivers 12a-c may also be an input/output component, such as an input pad.

Net layout 14 is a map of electrical connections on various layers in integrated circuit 10. Net layout 14 includes one or more nets 18 that interconnect one or more of drivers 12a-c and receivers 16a-c.

Receivers 16a-c are configured to receive signals generated from one or more of drivers 12a-c. Although three receivers 16 are illustrated, any suitable number of receivers may be coupled via nets 18 to one or more of drivers 12a-c. For example, receivers 16a-c may be a part of a logic component, such as an input pin of a flip-flop, latch, a buffer, and the like. In some embodiments, the receivers 16a-c are logic component pins. Receivers 16a-c may also be output ports.

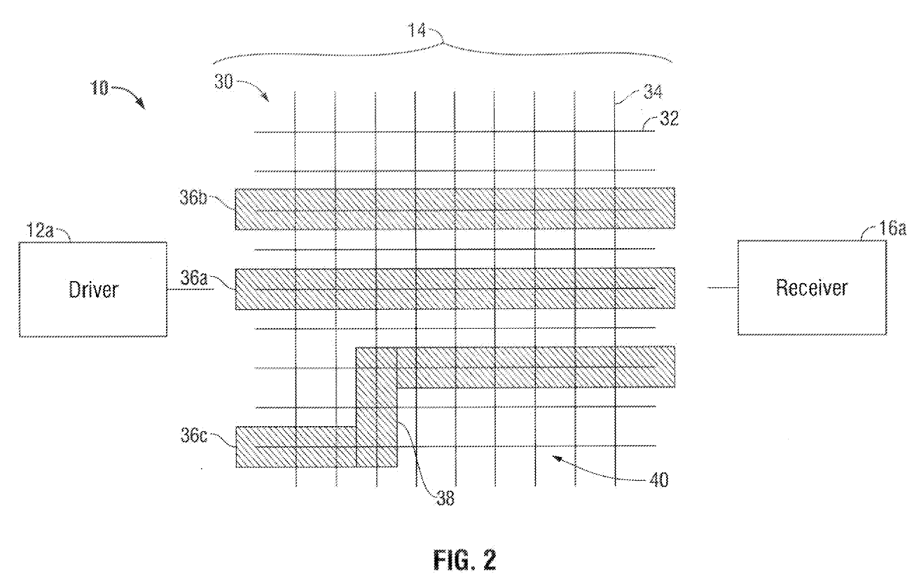

FIG. 2 is another graphical representation of an embodiment of integrated circuit 10 in which net layout 14 includes routing grid 30. Grid 30 includes horizontal gridlines 32 and vertical gridlines 34, which intersect to create gridpoints. Typically, routing a net involves routing a wire between certain gridpoints or pins within routing grid 30.

Although FIG. 2 only illustrates a single driver 12a and a single receiver 16a, it will be appreciated that nets with multiple receivers and/or drivers may be routed through grid 30. To maintain signal integrity on the signals being transmitted from driver 12a to receiver 16a, it is often desirable to ensure that the individual nets do not affect one another. Typically, a target separation between the individual nets is grid 30 is established during the design process to reduce the effect of individual nets in grid 30 on their neighbors.

For example, in FIG. 2, exemplary physical implementations 36a, 36b, or 36c of net 36 are separated from each other by at least one grid line. Physical implementations 36a, 36b, and 36c represent three possible implementations that could connect driver 12a and receiver 16a—depending on implementation, any one of the physical implementations 36a, 36b, or 36c could be chosen to connect driver 12a and receiver 16a. The distance of this target separation may vary depending on the attributes of the signals being transmitted over the nets. For some nets, a single minimum physical separation may be sufficient. In some embodiments, for example where cross-talk between nets is a concern, the target separation may have to be large enough to lessen capacitive coupling between the individual nets. These examples are not intended to be exclusive and, as those of ordinary skill in the art will appreciate, there are numerous additional signal attributes or other factors that can affect the desired target separation between nets.

At the same time, it is also often desirable for a particular net to take the shortest route between driver 12a and receiver 16a through net layout 14. The amount of time it takes for a signal to travel from driver 12a to receiver 16.a typically increases as net length increases. Because most integrated circuits operate on a clock, the “slowest” net and/or the slowest timing path may dictate the timing for the entire integrated circuit. In addition, many integrated circuit designers establish time thresholds for signals to travel between the driver 12a and the receiver 16a. If a particular net is so long that a signal cannot traverse between driver 12a and receiver 16a during the established time limit (e.g., 500 picoseconds), an error can develop on integrated circuit 10.

As described above there may be many drivers 12a-c and receivers 16a-c sharing a single net layout 14 or a section of net layout 14. Ideally, these drivers and receivers would be interconnected by nets that each took the shortest route through net layout 14 while still maintaining the target separation from other nets. In the reality of contemporary semiconductor design, however, this ideal is rarely, if ever, possible, and some nets may have to take less than optimal routes through net layout 14. For example, physical implementation 36b is two grid lines or “tracks” off center from the ideal route between driver 12a and receiver 16a and net 36c is both off-center and longer than the ideal route due to diversion 38 in the route of physical implementation 36c. Diversion 38 may be necessary, for example, to avoid another net (not shown), such as a net entering grid 30 from another layer of net layout 14 (also not shown).

One or more of the embodiments described below provides techniques for setting routes through net layout 14 that balance the competing concerns of each net based on the specific attributes of integrated circuit 10, driver 12a, receiver 16a, and/or the signals passing between them on the net 36 that connects driver 12a and receiver 16a. Moreover, the techniques may be employed before full global routing is performed on an integrated circuit design.

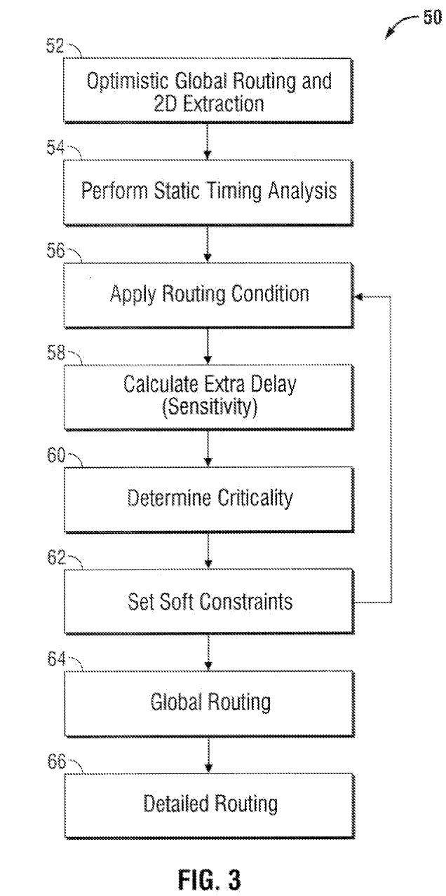

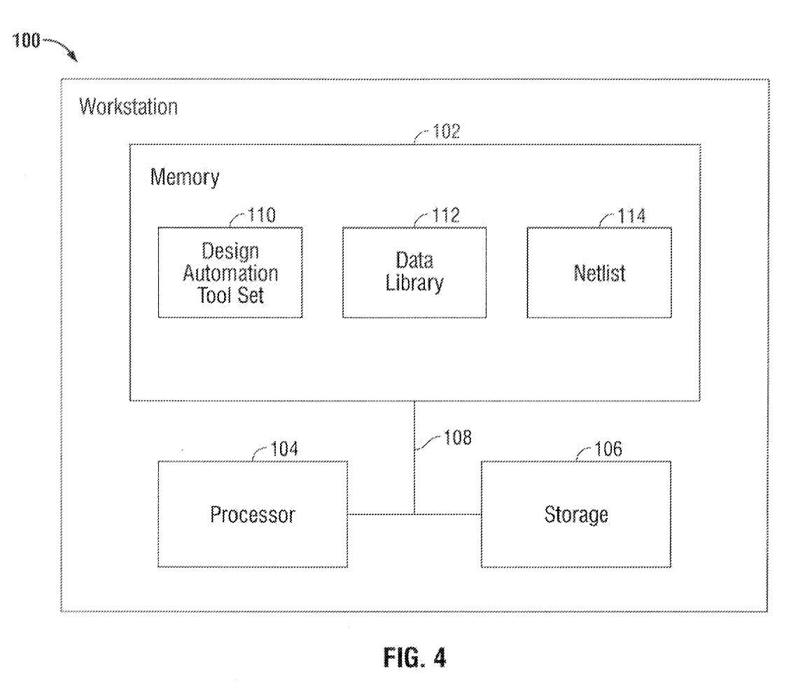

FIG. 3 illustrates a flow chart of an exemplary technique 50 for routing nets during design of an integrated circuit, such as integrated circuit 10. Technique 50 can be performed by hardware, software, or firmware on any suitable form of computer or computerized device, such as a router or routing tool running on a workstation. In various embodiments, technique 50 may either be executed as a stand-alone program or integrated into a larger set of design automation tools. For example, technique 50 may be integrated into routing software, such as NexusRoute produced by Pyxis Technology of Austin, Tex. Alternatively, technique 50 may also be integrated into other suitable analysis or design tools employing one or more of a number of standard interface formats, such as LEF, DEF, Verilog, VHDL, SDC, GCF, Liberty, SPEF, or other formats. These design tools are generically referred to herein as a “design automation tool set.” The operation of one exemplary design automation tool set is described in greater detail below and is illustrated in FIG. 4.

Referring again to FIG. 3, technique 50 may begin, as shown in process block 52, with one of the components of a design automation tool set performing an optimistic global routing and 2D extraction on a netlist for integrated circuit 10. The optimistic global route of a net is the best possible global route of the net that can be achieved in the absence of competition from other nets for routing resources. In embodiments employing NexusRoute, Pyxis routing parameters “-initial_route_only-cost usage” may be employed to determine the optimistic route2D. Parasitic extraction is a type of parasitic extraction applicable to global routes.

Parasitic extraction of a physical implementation (routes) of a net involves a process of calculating the capacitance, resistance, and inductance values corresponding to the route segments and determining the connectivity among these segments to create a parasitic network. The topology of the parasitic network and the values of its parasitic elements are used by delay calculator to determine the amount of time it takes for a signal to propagate from a driver to any of the receivers of the net. In some embodiments, a delay calculator is used to determine this time, in particular, in embodiments using static timing analysis. Since global routes of a net do not contain information about the exact geometries, 2D extraction employs probabilistic methods to estimate capacitance and resistance of such routes.

Next, technique 50 may involve a component of the design, automation tool set performing a static timing analysis on drivers 12a-c and receivers 16a-c using a netlist for integrated circuit 10, as indicated by block 54. In some systems, a timing tool may perform the static timing analysis. As those of ordinary skill in the art will appreciate, performing a static timing analysis may involve determining the signal timing along an ideal or optimistic (i.e., shortest) route for each net on the netlist. In some embodiments, determining the signal timing includes determining timing along a timing path that includes multiple nets in series.

The static timing analysis also involves determining slack for each net in the netlist, for integrated circuit 10. In some embodiments, determining slack for the net involves first determining slack for a timing path that may include multiple nets in series. The slack for the timing path can be determined by subtracting the ideal timing for the timing path from the permissible delay for the timing path. The permissible timing for the entire path may be part of a specification or set of design/timing rules for integrated circuit 10. For example, the permissible timing may be based on a desired clock frequency for integrated circuit 10.

After the slack is determined for the net, the technique 50 may include applying a routing condition to the net, as indicated by block 56. A routing condition is a shortcoming/imperfection in a physical implementation of a net. In some embodiments, the routing condition is characterized by a number indicative of the severity of the condition. One exemplary routing condition is a detoured routing. A detour of a net routing is routing with a wire length that is longer than the shortest or ideal route through net layout 14. A detour routing condition may be characterized by a detour factor, which is indicative of the degree of the detour. For example, the detour routing condition may be a percentage (e.g., 50%, 100%, 150%) increase in wire length. Another exemplary routing condition is crosstalk which correlates to net slowdown by capacitive crosstalk from other nets. A crosstalk routing condition may be characterized by a Miller factor. In still other examples, any one of a number of other suitable routing conditions may be selected.

After the routing condition is applied, the technique 50 may include calculating an extra delay in the instance driving the net and along the net as a result of the routing condition, as indicated by block 58. For example, if the routing condition is a detour with a 50% increase in wire length and the delay along the ideal route is 4 nanoseconds, the 50% increase in wire length may add 3 ns of extra delay on the net (if the net delay is linear) or 4 ns of delay (if the net delay is quadratic). Similarly, if the routing condition is crosstalk, applying the routing condition may involve increasing the Miller factor on the net by a factor of 2× or 2.5×, for example, and calculating the resulting delay along the net (e.g., 6 ns). This extra delay together with the extra delay in the instance driving the net is referred to as the sensitivity of the net. In some embodiments, the extra delay may include an extra delay related to delay in a driver instance or a delay caused by another net in a timing path.

Once the extra delay that would result from the routing condition is computed, a criticality of the net to the extra delay can be determined, as indicated by block 62. In some exemplary embodiments, determining the criticality of the net involves determining an adjusted slack value for the net. Adjusted slack is determined by subtracting the extra delay that would be caused by the routing condition from the slack on the net (see block 54 above). If the extra delay would exceed the slack, then the net is determined to be critical with respect to the routing condition. Typically, the smaller the adjusted slack the more critical the net. In other embodiments, different techniques may also be employed to determine if the net is sensitive to the routing condition.

In some embodiments, blocks 56-62 may then be repeated to determine the criticality based on other routing conditions and/or other nets. For example, blocks 56-60 may be performed once to determine the criticality for a detour routing condition and another time for a crosstalk routing condition. In other embodiments, blocks 56-60 may involve computing these two criticalities at the same time or in a co-pending manner.

Based at least partially on the determined criticality of the net, the technique 50 may next involve setting a soft constraint for the net, as indicated by block 64. A soft constraint is a control, in a router or routing tool, for example, that can be applied on a net to reduce the probability and severity of the routing condition on that net. For example, the soft constraint may be a limitation on detouring the net either at all or by a certain amount.

The soft constraint is termed “soft”, because it is typically not possible to satisfy every soft constraint during global routing and detail routing of integrated circuit 10. As such, some soft constraints may have to be ignored, as described further below. In some embodiments, the technique 50 may include sorting the net into one or more “bins” based on that net's criticality. For example, the router may maintain one bin for the most critical soft constraints, another for slightly less critical soft constraints, and so on. For example, those nets with smaller adjusted slack can be placed into a more critical bin than other nets with larger adjusted slack values. Alternatively, the soft constraints may be sorted into linear order based on their individual adjusted slack values. Still other suitable statistical models or calculations, such as fuzzy logic, may also be employed for determining the best set of constraints.

After soft constraints have been determined for the desired number of nets, the technique 50, the router will perform a global routing, as indicated by block 68 of FIG. 3. In some embodiments, the router will perform global routing of the integrated circuit 10 starting with the most critical soft constraints and working down to the least critical soft constraints. In some embodiments, the router will perform global routing beginning with a bin of most critical nets, then proceeding to the second most critical bin, and so forth.

In various embodiments, global routing may involve one or more of the following, nonexclusive steps:
(1) Overall route planning with 3D wire balancing for metal density and density gradient control;
(2) 2D wire spreading to reduce critical areas for shorting defects; and
(3) Automated progressive timing closure flow using wire layer assignment and use of non-default rules for DFM and for signal integrity.

Ideally, the global routing will apply all of the soft constraints. To the extent that it is not possible for the router to apply all of the soft constraints, the most critical soft constraints may be applied by the router first. For example, if the criticality analysis involved binning the soft constraints, those nets having soft constraints in the highest priority bin would be routed first, generally followed by those nets having soft constraints in the next highest priority bin, and so on. The router may also be configured to sort the soft constraints within each bin. As those of ordinary skill will appreciate, the router is configured to perform a global routing based on the soft constraints.

After global routing is complete, the router will perform detailed routing, as indicated by block 70. In various embodiments, detailed routing may involve one or more of the following, nonexclusive steps:
(1) Signals are routed correct-by-construction layout with incremental DRC during routing;
(2) 2D wire spreading for DFM;
(3) Application of preferred design rules;
(4) Replacement of single vias with double vias;
(5) Other via treatments if vias can not be doubled;
(6) Widening of wires to reduce critical area for “open” type defects; and
(7) Protection of lithography sensitive patterns.

Conventional routers often encounter critical design problems during detail routing when two different steps (e.g. two design rules) cannot be reconciled. When these critical design problems are encountered by conventional routers, there is typically little choice but to make a manual change to the detailed routing parameters and to start the detailed routing process again. As the detailed routing process is typically the most time consuming and expensive portion of the wire routing process, it is desirable to reduce the number of times that detailed routing must be performed to arrive at a manufacturable design (ideally to a single detailed routing). Advantageously, technique 50 enables the router to perform global and detailed routing on the nets of integrated circuit 10 in an order that is based on the criticality of the net and its sensitivity to routing conditions. In doing so, design conflicts, such as crosstalk, that conventionally appear during detail routing are proactively addressed. Thus, implementation of technique 50 may reduce the time and expense of integrated circuit design.

As described above, technique 50 may be stored or embodied in hardware, software, or firmware that is executed by one or more tools in a design automation tool set. FIG. 4 illustrates one exemplary embodiment of a workstation 100 configured to execute a design automation tool set capable of performing technique 50. Workstation 100 may, for example, include a memory 102, a processor 104, and storage 106 interconnected via bus 108. In some examples, workstation 100 includes a desktop computer or other suitable computerized device.

Memory 102 may include a number of individual, volatile or non-volatile memory modules that store segments of operating system and, application software while power is supplied to router 100. Memory 102 may store a design automation tool set 110, library data 112 and netlist 114. Logic design tool 110 may include instructions capable of being executed by processor 104. In an alternative, design automation tool set 110 could be implemented by control circuitry through the use of logic gates, programmable logic devices, or other hardware components in lieu of a processor-based system. In at least one example system, design automation tool set 110 includes a version of NexusRoute software that has been configured to execute technique 50, as described above.

Processor 104 controls the operation of the workstation 100, including executing the arithmetic and logic functions contained in a particular computer program within memory 102. Although not depicted in FIG. 4, processor 102 typically includes a control unit that organizes data and program storage in a computer memory and transfers the data and other information between the various parts of the computer system. Processor 104 also generally includes an arithmetic unit that executes arithmetical and logical operations, such as addition, comparison, and multiplication. Processor 104 accesses data and instructions from and stores data to memory 102. Although workstation 100 is shown to contain only a single processor 104 and a single bus 108, multiple processors and/or multiple bus routers may also be employed. A multi-processor system may be particularly advantageous in embodiments that process multiple soft constraints in parallel, as described above.

Storage 106 can be any type of storage device, such as a hard-disk drive, or a CD-ROM drive. Although storage 106 is shown as being incorporated within workstation 100, it could be external to workstation 100, either connected directly or on a local area network, on an external network, or attached to a remote computer system.

In various embodiments, workstation 100 can be implemented utilizing any suitable computer such a UNIX workstation, a PC, or other suitable computerized device, any of which are available from a variety of vendors. However, technique 50 can be executed on any computer system or configuration that allows circuit design, regardless of whether the computer system is a complicated, multi-user computing apparatus or a single-user work station

Many of the embodiments described above pertain to specific method steps implementable on a computer system or as a computer program product for use with a computer system. The programs defining the functions of the embodiment can be delivered to a computer via a variety of instruction-bearing media, which include, but are not limited to, (1) information permanently stored on non-writeable storage media (e.g., CD-ROM disks); (2) alterable information stored on writeable storage media (e.g., a hard-disk drive); or (3) information conveyed to a computer by a communications media, such as through a computer or telephone network, including wireless communications. Such instruction-bearing media when carrying computer-readable instructions that direct the functions of the above described embodiments are within the scope of those embodiments.

Although numerous embodiments have been described in detail above, it will be apparent to those skilled in the art that many additional embodiments taking a variety of specific forms and reflecting changes, substitutions, and alterations can be made without departing from the spirit and scope of the invention. The described embodiments illustrate the breadth of the claims but should not be interpreted to restrict the scope of the claims.

1. A computerized method of designing an integrated circuit, the method comprising:
determining slack for a net in a netlist;
applying a routing condition to the net;
calculating an extra delay related to the routing condition;
determining a criticality of the net considering the extra delay and the determined slack; and
setting a soft constraint based at least partially on the criticality.

2. The method of claim 1, wherein determining the criticality of the net comprises determining the criticality of the net considering an extra delay related to delay in a driver instance.

3. The method of claim 1, wherein determining the criticality of the net comprises determining the criticality of the net considering an extra delay of another net in a timing path with the net.

4. The method of claim 1, wherein determining a criticality of the net considering the extra delay comprises determining the criticality of the net considering two or more extra delays.

5. The method of claim 1, comprising performing global routing for the integrated circuit based at least partially on the soft constraint.

6. The method of claim 1, comprising assigning the net to a bin based at least partially on the criticality, wherein performing the global routing comprises performing a global routing of the netlist in an order based on bin assignment.

7. The method of claim 6, wherein the global routing comprises applying a plurality of soft constraints during the global routing.

8. The method of claim 1, wherein the routing condition is a detour.

9. The method of claim 8, wherein calculating the extra delay related to the routing condition comprises calculating the extra delay if the length of the net is increased in length by a detour factor.

10. The method of claim 9, wherein calculating the extra delay if the length of the net is increased in length comprises calculating the extra delay if the length of the net is increased in length by a detour factor of approximately 100%.

11. The method of claim 1, wherein routing condition is crosstalk.

12. The method of claim 11, wherein calculating the extra delay related to the routing condition comprises calculating the extra delay if a Miller factor is increased.

13. The method of claim 1, wherein the routing condition is a wire width of the net.

14. A computerized method of designing an integrated circuit, the method comprising:
performing a static timing analysis to determine a slack for each of a plurality of proposed nets for an integrated circuit design;
increasing the length of one or more of the plurality of proposed nets by a factor related to a routing condition to determine an extra delay for each of the one or more nets resulting from the routing condition; and
performing a global routing for the integrated circuit design based at least partially on the slack and the extra delay.

15. The method of claim 14, comprising determining an adjusted slack for each of the nets based on the slack and the extra delay.

16. The method of claim 15, wherein performing the global routing comprises performing the global routing based on the adjusted slack.

17. The method of claim 14, wherein increasing the length comprises increasing the length of the net by a percentage of the net's ideal length as determined by optimistic routing.

18. The method of claim 14, wherein performing the global routing comprises performing the global routing in an order based at least partially on one or more soft constraints, the soft constraints based at least partially on the slack and the extra delay of the one or more nets.

19. The method of claim 14, wherein increasing the length of one or more of the plurality of proposed nets by a factor related to a routing condition comprises increasing the length by a factor related to a detour.

20. The method of claim 19, wherein the factor related to a detour comprises an approximately 100% increase in net length.

21. A tangible, computer readable medium comprising instructions that when executed cause a computer to:
determine slack for a net in a netlist;
apply a routing condition to the net;
calculate an extra delay related to the routing condition;
determine a criticality of the net taking into account the extra delay; and
set a soft constraint based at least partially on the criticality.

22. The computer readable medium of claim 21, comprising instructions that when executed cause a computer to:
perform a global routing for an integrated circuit based at least partially on the soft constraint.

23. The computer readable medium of claim 21, wherein the routing condition comprises a detour.

24. The computer readable medium of claim 21, wherein the routing condition comprises a crosstalk.
